(19) United States
(12) Patent Application Publication
(10) Pub. No.: US 2005/0013054 A1
(43) Pub. Date: Jan. 20, 2005

(54) Inertial latching mechanism and information recorder using the mechanism

(76) Inventors: Makoto Miyamoto, Hyogo (JP); Hideki Kumajima, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/883,674

(22) Filed: Jul. 6, 2004

(30) Foreign Application Priority Data
Jul. 18, 2003 (JP) 2003-276864

(51) Int. Cl. G11B 5/54; G11B 21/22

(52) U.S. Cl. 360/256.4

(57) ABSTRACT

An inertial latching mechanism of high reliability, which can be incorporated in a slim profile disk drive or the like information recorders. Describing practically, the mechanism includes freely revolvable inertia arm 6 which couples with actuator 3when head arm is in a shunt position or the vicinity, whereas the coupling is released when the actuator is in proximity with disk 1 or the neighborhood; a drive means for holding inertia arm 6 to a right posture by taking advantage of magnetic pulling force at the place where the inertia arm is released from the coupling with actuator 3. Furthermore, coil arm 9's restriction section 9b and inertia arm 6's contact section 6b are disposed opposed to each other for forming a revolution restriction means which restricts an anti-clockwise revolution of inertia arm 6, as viewed from the above, when coil arm 9's coupling section 9a and inertia arm 6's coupling section 6a are in uncoupled state. The above-configured inertial latching mechanism can be used in a magnetic disk drive, an optical disk drive, a magneto-optical disk drive and other disk information recorders.

### FIELD OF THE INVENTION

The present invention relates to an actuator for use in the disk information recorders, which recorders containing the floating type signal conversion devices such as a magnetic head, an optical head, etc. The disk information recorders include a magnetic disk drive, an optical disk drive, a magneto-optical disk drive, etc. More specifically, an improved inertial latching mechanism for actuator; even if an unloading actuator is hit by an external shock at a shunt location during off-operation, the improved latching mechanism prevents the actuator from inadvertently drifting onto the recording medium. An information recorder incorporating the improved inertial latching mechanism is also disclosed in the present invention.

### BACKGROUND OF THE INVENTION

The magnetic disk drives, a. o. those built in note book type personal computers or the like portable apparatus are requested to have a high reliability against mechanical shocks during off-operation.

Once a slider mounted on actuator is displaced by an external shock during off-operation from a shunt position onto a disk data region, it may well stick on the surface of the data disk or give damage on the stored data causing serious inconvenience.

There have been actuator lock mechanisms for holding an off-operation actuator retained in a shunt position. The mechanism is intended to prevent the actuator from being affected by an external shock and moving out onto the surface of disk data region.

Among the recent magnetic disk drives, a slider load/unload device (sometimes simplified as L/UL) is schemed for preventing a slider from sticking onto the surface of shunt region, or for improving the anti-shock reliability. The load/unload device holds an actuator during off-operation with a component called ramp disposed in the neighborhood of a disk's outer circumference. Thereby, a slider is shunted and kept to be free from making a contact with disk surface.

An inertial latching mechanism is among the actuator lock mechanisms. In many of the actuator lock mechanisms using an inertial latching mechanism, the above-described ramp of load/unload device and a magnetic lock mechanism utilizing a solenoid, or a magnet, are used combined.

The inertial latching mechanism operates when a magnetic disk drive is hit by an external mechanical shock; the mechanism makes use of an inertia force generated by the shock to latch the actuator (“latch” here means to hold and fix a certain state temporarily). The inertial latching mechanism can latch an actuator against a strong mechanical shock, which shock can not be encountered by the above-described magnetic lock mechanism alone. The earlier-described actuator lock mechanism protects an actuator from a weak shock, which shock can not be encountered by the inertial latching mechanism. Thus, the operational reliability of actuator lock mechanisms has been improved.

FIG. 9 shows an example of actuator lock mechanism using the inertial latching mechanism. FIG. 9 shows an outline plan view of a magnetic disk drive, which is used to describe a conventional inertial latching mechanism. This actuator lock mechanism uses a ramp of load/unload device for holding the actuator (proposed in Japanese Patent Laid-Open Application Nos. JP2001-273736, JP2002-190171, JP10-302418, for example).

In the inertial latching mechanism shown in FIG. 9, when a magnetic disk drive is off-operation and unloaded actuator 91 is at shunt position of ramp block 92, coil arm 93 of actuator 91 is held by a part of inertia arm 94 which is supported in a case (not shown) to be freely revolvable. Coupling section of coil arm 93 and inertia arm 94 has an involute shape which is generally used among toothed wheels; and the two arms are in engaged state.

If, during off-operation, a magnetic disk drive is hit by an anti-clockwise shock, as viewed from above FIG. 9, actuator 91 receives anti-clockwise revolving force due to angular acceleration caused by the shock. Likewise, inertia arm 94 also receives an anti-clockwise revolving force. There are contradictory forces working in actuator 91's coil arm 93 and inertia arm 94 at their coupling section. In actuator 91 and inertia arm 94, the mass has been balanced with respect to their centers of revolution. Thus, influence of linear acceleration due to the shock is suppressed, and an inertia ratio of actuator 91 versus inertia arm 94 is made to be identical with a distance ratio of coupling section to revolving center of actuator 91 versus coupling section to revolving center of inertia arm 94. As the result, torques in actuator 91 and inertia arm 94 at their respective coupling sections become identical, and their actions at the coupling section are suppressed to each other. Namely, actuator 91 is prevented from drifting onto the disk surface area, even if it is hit by a revolving shock.

Likewise, if it is hit by a clockwise revolving shock, as viewed from above FIG. 9, actuator 91 and inertia arm 94, respectively, receive clockwise revolving force due to angular acceleration caused by the shock. These clockwise forces work contradictory to each other at their coupling section. Since torques of actuator 91 and inertia arm 94 at their coupling sections are identical, their mutual actions are suppressed to each other. Namely, actuator 91 is prevented from drifting onto the disk surface area, even if it is hit by a revolving shock.

In the above-described conventional inertial latching mechanism, actuator 91 and inertia arm 94 are coupled when actuator 91's head arm 95 is at the shunt position or the vicinity, whereas the coupling is released when it is in proximity with the disk or in the neighborhood. If it is hit by an external revolving shock while actuator 91 is in the shunt position, both of actuator 91 and inertia arm 94 receive, respectively, revolving moments of the same direction. Therefore, their actions at the coupling section are suppressed to each other, and drifting of actuator 91 onto data region can be avoided.

In this way, actuator 91 can be held retained at shunt position despite an external shock, in so far as it is in the shunt position. However, if it is hit by an anti-clockwise external shock, as viewed from the above, during recording/playback or loading/unloading operations and actuator 91 and inertia arm 94 are in uncoupled state, inertia arm 94 receives anti-clockwise revolving force and makes anti-clockwise revolution. Especially, if the anti-clockwise shock is given while actuator 91 is unloading and when actuator 91 and inertia arm 94 are just before making coupling, inertia arm 94 makes an anti-clockwise revolution, as viewed from the above. Actuator 91 also receives an anti-clockwise revolving force. However, since actuator 91 is in unloading operation, it is having a clockwise revolving force from voice coil motor 96, or means for moving head arm 95. So, the anti-clockwise motion of actuator 91 is suppressed to be weak; as a result, actuator 91 may arrive at the point of coupling with inertia arm 94 after inertia arm 94 made an anti-clockwise revolving shift. This brings about a discrepancy in the coupling phase between actuator 91 and inertia arm 94, which makes it difficult to implement a normal state of coupling. Actuator 91's involute coupling section would come into contact with inertia arm 94 at the non-coupling section, which is not involute-shaped. Such an abnormal encounter blocks consummation of actuator 91's unloading operation, which would lead the disk drive out of order. Even if the unloading operation is finished, the coupled-state is not normal; as the result, the inertial latching mechanism is not prepared to start the normal operation. Therefore, if it is hit by an anti-clockwise revolving shock while the disk drive is off-operation, actuator 91 may revolve anti-clockwise to drift onto the disk surface. Then, a slider mounted on actuator 91 might be sticking on the disk surface at the data region, or colliding on the disk surface to give damage thereto. Thus, there exists a possibility of serious disorder, even the destruction of stored data.

### SUMMARY OF THE INVENTION

The present invention aims to solve the above drawbacks, and improve the inertial latching mechanism so that it can hold and retain an actuator without fail upon receiving a shock from outside. Thus a high reliability inertial latching mechanism that can be incorporated even in flat and slim-profile disk drives is offered. An information recorder incorporating the latching mechanism is also disclosed in the present invention.

An inertial latching mechanism in the present invention includes an actuator for use in information recorder supported to be freely revolvable with sway around the revolution axis of a bearing, which actuator being formed of a head arm mounted with a head and a coil arm mounted with a coil and provided with coil arm's coupling section and restriction section; and a freely revolvable inertia arm held to a right posture by a drive means and provided with the inertia arm's coupling section and contact section. The coil arm's restriction section and the inertia arm's contact section constitute a means for restricting the revolution of inertia arm. The coil arm's restriction section has a fan shape of a certain specific radius centered at the actuator's revolving axis. When the coil arm's coupling section and the inertia arm's coupling section are in an uncoupled state, the fan shape of coil arm's restriction section resides in a region which is facing to the inertia arm's contact section.

If an information recorder is hit by an anti-clockwise revolving shock, as viewed from the above, during recording/playback operation or load/unload operation, specifically when the coil arm and the inertia arm are in uncoupled state, the inertia arm's contact section gets in contact with the side-wall of the fan shape portion of the coil arm's restriction section. Thus, range of the inertia arm's revolution is limited, and it can make no further anti-clockwise revolution. As the result, the coil arm and the inertia arm can keep a stance of standby for engagement, so that coil arm's coupling section can make intrusion into inertia arm's coupling section any time.

In an inertial latching mechanism in the present invention, the coil arm's restriction section and the inertia arm's contact section are disposed so that there is a small gap between the coil arm's restriction section and the inertia arm's contact section while they are in an opposing state.

The above configuration ensures free revolving of the actuator in the normal recording/playback and load/unload operations, without any disturbance by the inertia arm. At the same time, the stance of standby for engagement is maintained.

In an inertial latching mechanism in the present invention, location of the inertia arm's contact section and a certain specific radius of the fan shape of coil arm's restriction section are determined so that there is a small gap between the coil arm's coupling section and the inertia arm's coupling section while coil arm's restriction section is in contact with the inertia arm's contact section.

The above configuration ensures free revolution of the actuator even if information recorder is hit by an external shock during normal recording/playback and load/unload operations, without any disturbance by the inertia arm. At the same time, the stance of standby for engagement is maintained.

In an inertial latching mechanism in the present invention, the coil arm's coupling section and inertia arm's coupling section are structured, respectively, in an involute shape; or, the coil arm's coupling section is a column-shape coupling post whose axis is in parallel with the actuator's revolution axis, provided on the coil arm, and makes a loose coupling with the inertia arm's coupling section.

These configurations make the coupling, or uncoupling, of coil arm and inertia arm smooth. In addition, it performs a shock absorbing function based on the instantaneous balancing between actuator and inertia arm of revolving forces due to an external shock given while actuator is in shunt position more reliable.

In an inertial latching mechanism in the present invention, the drive means is formed with a magnetic member attached to the inertia arm and a permanent magnet constituting a voice coil motor; or, an inertia arm made of magnetic material and a permanent magnet constituting a voice coil motor.

The above configuration ensures that an inertia arm is held to an uncoupling position providing a stable state of standby for coupling of inertia arm and coil arm during unloading operation.

An information recorder in the present invention includes a revolving recording medium having a recording layer; an actuator having a head arm mounted with a head and a coil arm mounted with a coil, which actuator being supported to be freely revolvable with sway around the revolving axis of a bearing, and loads/unloads the head arm onto the recording medium by revolving and swaying; a voice coil motor formed with a coil mounted on the coil arm, a pair of yokes opposing to the upper and lower end-faces of the coil and a permanent magnet attached to at least one of the yokes on the surface facing to the coil; and a ramp block provided at a shunt position for the actuator. The mechanism for latching the actuator is formed by the coil arm's coupling section and restriction section, and a freely revolvable inertia arm which is held to a right posture by a drive means and provided with inertia arm's coupling section and contact section. The latching mechanism further includes a means for restricting revolution of the inertia arm, which means is formed of the restriction section of coil arm and the contact section of inertia arm. The coil arm's restriction section has a fan shape of a certain specific radius centered at the actuator's revolving axis. When the coil arm's coupling section and the inertia arm's coupling section are in uncoupled state, the fan shape of coil arm's restriction section resides in a region which is facing to the inertia arm's contact section.

If an information recorder is hit by an anti-clockwise revolving shock, as viewed from the above, during recording/playback operation or load/unload operation, specifically when the coil arm and the inertia arm are in uncoupled state, the inertia arm's contact section makes a contact with the side-wall of the fan shape portion of the coil arm's restriction section. Thus, the revolution range of inertia arm is limited, and it can make no further anti-clockwise revolution. As the result, the coil arm and the inertia arm can keep a stance of standby for engagement, so that coil arm's coupling section can make intrusion into inertia arm's coupling section any time. Thus the anti-shock performance of an information recorder is improved, and the reliability is raised.

In an information recorder in the present invention, the coil arm's restriction section and the inertia arm's contact section are disposed so that there is a small gap between the coil arm's restriction section and the inertia arm's contact section while they are in an opposing state.

The above configuration ensures free revolving of the actuator in the normal recording/playback and load/unload operations, without any disturbance by the inertia arm. At the same time, the stance of standby for engagement is maintained. Thus, the anti-shock performance of an information recorder is improved, and the reliability is raised.

In an information recorder in the present invention, location of the inertia arm's contact section and a certain specific radius of fan shape of coil arm's restriction section are determined so that there is a small gap between the coil arm's coupling section and the inertia arm's coupling section while coil arm's restriction section is in contact with the inertia arm's contact section.

The above configuration ensures free revolution of the actuator even if an information recorder is hit by an external shock during normal recording/playback and load/unload operations, without any disturbance by the inertia arm. At the same time, the stance of standby for engagement is maintained. Thus, the coil arm and the inertia arm can be coupled without fail; the anti-shock performance of an information recorder is improved, and the reliability is raised.

In an information recorder in the present invention, the coil arm's coupling section and inertia arm's coupling section are structured, respectively, in an involute shape; or, the coil arm's coupling section is a column-shape coupling post whose axis is in parallel with the actuator's revolution axis, provided on the coil arm, and makes a loose coupling with the inertia arm's coupling section.

These configurations make the coupling of coil arm and inertia arm smooth. In addition, it makes a shock absorbing function based on the instantaneous balancing between actuator and inertia arm of revolving forces due to an external shock given while actuator is in a shunt position more reliable. Thus the anti-shock performance of an information recorder is improved, and the reliability is raised.

In an information recorder in the present invention, the drive means is formed with a magnetic member attached to the inertia arm and a permanent magnet constituting a voice coil motor; or, an inertia arm made of magnetic material and a permanent magnet constituting a voice coil motor.

The above configuration ensures holding of an inertia arm to the uncoupling location, and provides a stable state of standby for coupling of inertia arm and coil arm during unloading operation. Thus, the coil arm and the inertia arm can be surely coupled without fail; and the anti-shock property of an information recorder is improved, and the reliability is raised.

As described in the above, the present invention includes a freely revolvable inertia arm which couples with the actuator when head arm of the actuator is at a shunt position or the vicinity and uncouples when it is in proximity to a recording medium or the neighborhood, and a drive means for holding the inertia arm to a right posture by the help of a magnetic pulling force at the point of uncoupling from the actuator. Furthermore, the coil arm of actuator is provided with a restriction section, and the inertia arm is provided with a contact section; and the coil arm's restriction section and the inertia arm's contact section are disposed opposed so that there is a small gap in between while the coil arm's coupling section and the inertia arm's coupling section are in uncoupled state. A means for restricting anti-clockwise revolution, as viewed from above, of inertia arm is thus constituted. Therefore, even if it is hit by an external revolving shock during recording/playback or loading/unloading operations, specifically when the actuator and the inertia arm are in uncoupled state, anti-clockwise revolution of the inertia arm, as viewed from above, is restricted, and the inertia arm can stay in the stance of standby for engagement with the coil arm, or the actuator. So, the inertia arm and the actuator during unloading can be coupled without fail. Therefore, an abnormal collision of the coil arm's coupling section against a side protrusion of inertia arm's coupling section can be avoided, which collision would be leading to a coupling failure between the actuator and the inertia arm, and to an unfinished unloading operation.

If it is hit by an external revolving shock while actuator is in shunt position, actuator and inertia arm are affected, respectively, by revolving moments of the same direction; so, actions of the actuator and the inertia arm are restricted to each other at their coupling section. Thus the actuator is prevented from drifting onto the data region. While on the loading process, the inertia arm is held to a right posture at the point of uncoupling from the actuator, by a drive means, or a magnetic pulling force. Therefore, the uncoupling and coupling operations between actuator and inertia arm during loading/unloading can be made without fail.

### BRIEF DESCRIPTION OF THE DRAWINGS

FIG. 1 is a plan view showing the key portion of an information recorder incorporating an inertial latching mechanism in accordance with an exemplary embodiment of the present invention.

FIG. 2 is a cross sectional view showing the outline of the mechanism of FIG. 1, sectioned along the line A-A.

FIG. 3 is a plan view showing the key portion of an exemplary information recorder; actuator is shown loaded.

FIG. 4 is a plan view showing the key portion of an exemplary information recorder; slider is shown just before it is leaving from disk.

FIG. 5 is a partly enlarged view of an exemplary inertial latching mechanism; a state just before coupling of actuator and inertia arm is shown.

FIG. 6(a) is a magnified perspective view of a coil arm's coupling section in an exemplary embodiment.

FIG. 6(b) is a magnified perspective view of an inertia arm in an exemplary embodiment; viewed from the underneath.

FIG. 7 is a plan view showing the key portion of an exemplary information recorder; actuator is shown unloaded.

FIG. 8 illustrates a typified dynamics between actuator and inertia arm in an exemplary embodiment.

FIG. 9 is a plan view showing the outline structure of a magnetic disk drive, used to describe a conventional inertial latching mechanism.

### DETAILED DESCRIPTION OF THE INVENTION

Exemplary embodiment of the present invention is described in the following with reference to the drawings.

### FIRST EMBODIMENT

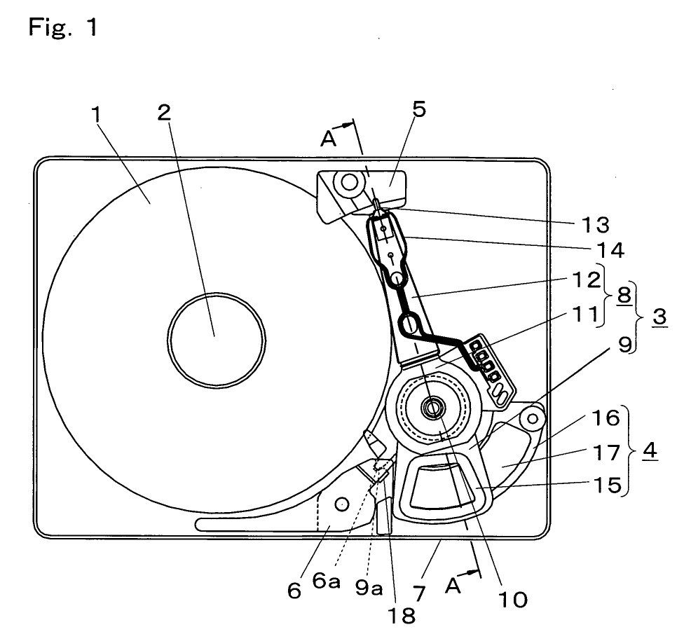

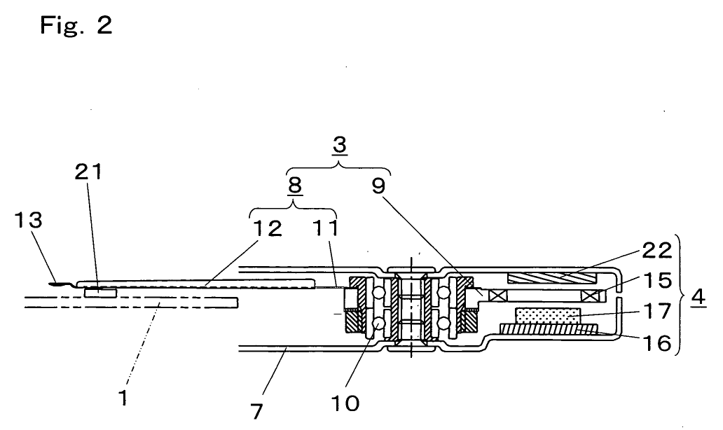

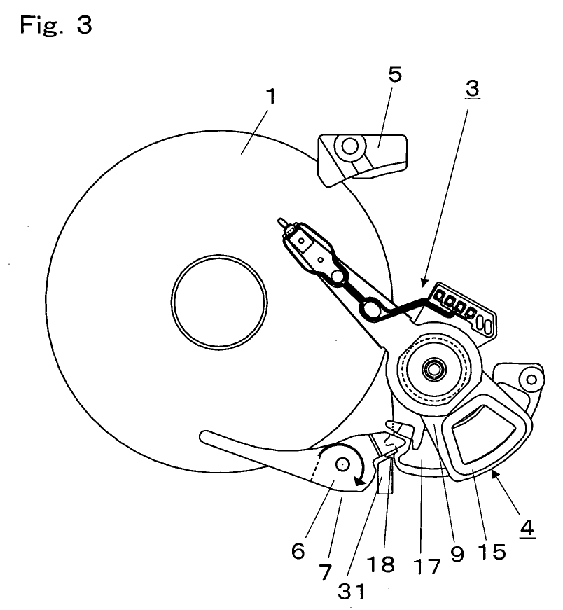

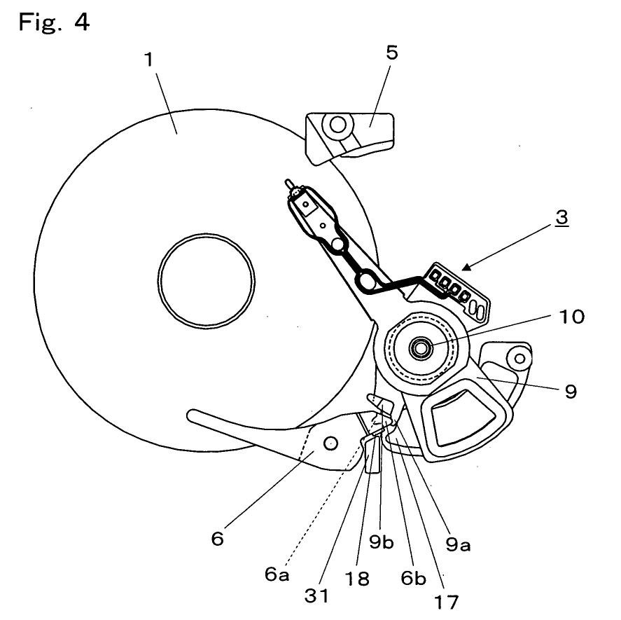

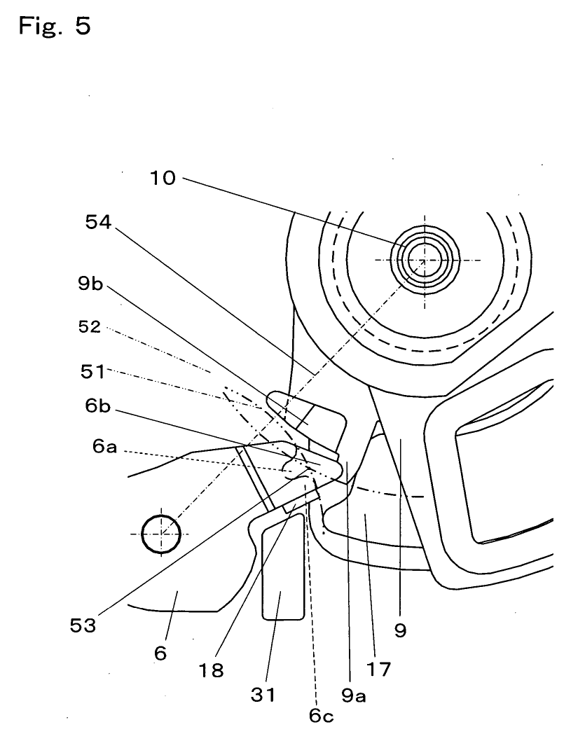

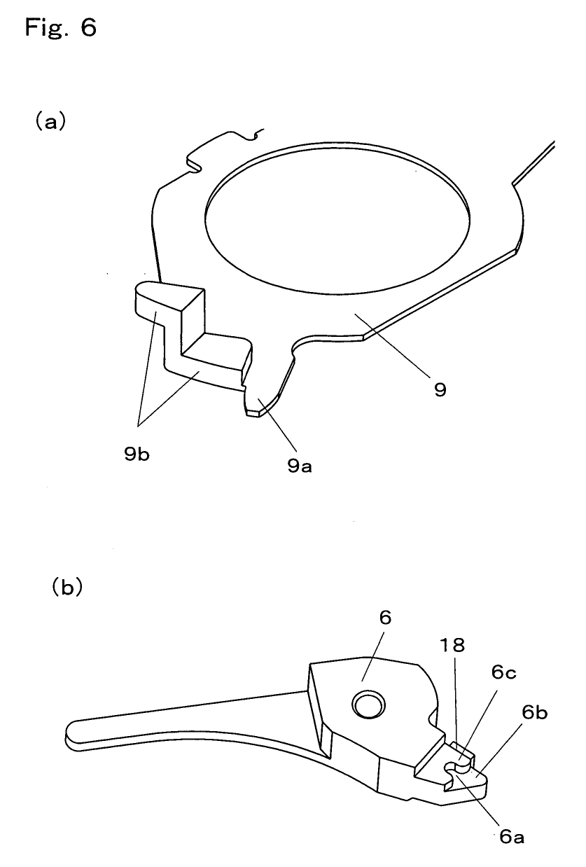

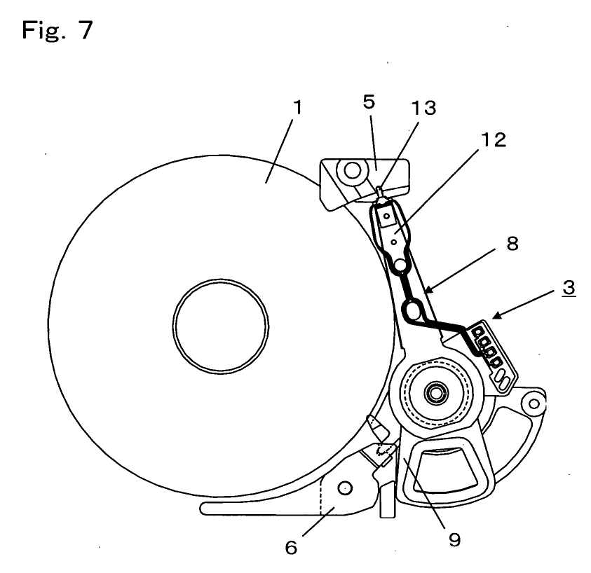

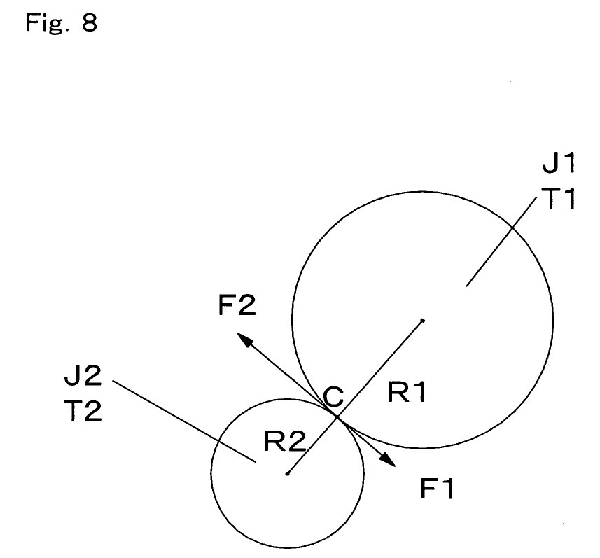

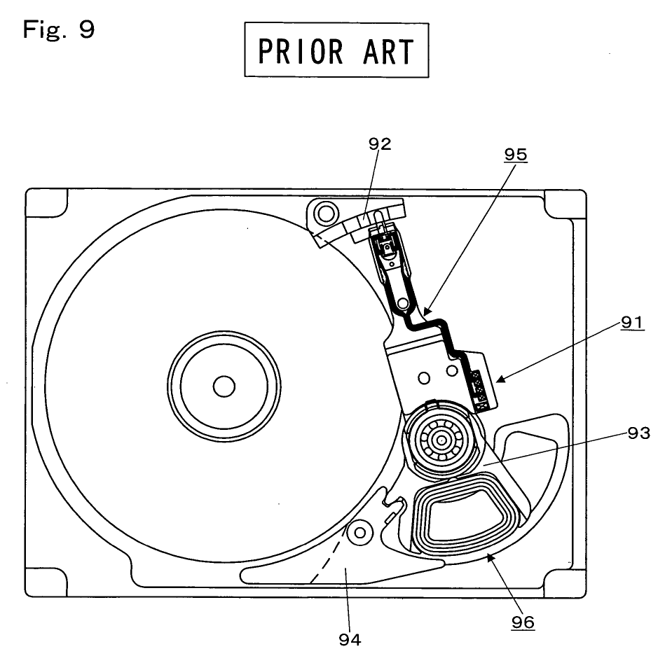

FIG. 1, FIG. 2, FIG. 3, FIG. 4, FIG. 5, FIG. 6, FIG. 7 and FIG. 8 are the drawings used to describe an inertial latching mechanism incorporated in an information recorder in accordance with an exemplary embodiment of the present invention. FIG. 1 is a plan view showing the key portion of an information recorder incorporating an inertial latching mechanism in accordance with an exemplary embodiment of the present invention; shown the upper lid and the upper yoke around voice coil motor eliminated. FIG. 2 is a cross sectional view showing the outline of the mechanism of FIG. 1, sectioned along the line A-A. FIG. 3 is a plan view of the key portion of information recorder; actuator is shown loaded. FIG. 4 is a plan view of the key portion of information recorder; slider is shown just before it is leaving from disk. FIG. 5 is a partly enlarged view of an inertial latching mechanism; shown in a state just before actuator and inertia arm are coupled. FIG. 6(a) is a magnified perspective view of a coil arm's coupling section in an exemplary embodiment. FIG. 6(b) is a magnified perspective view of an inertia arm in an exemplary embodiment; viewed from the underneath. FIG. 7 is a plan view of the key portion of an exemplary information recorder; actuator is shown unloaded. FIG. 8 illustrates a typified dynamics between actuator and inertia arm.

Now in the following, a magnetic disk drive is described as an example of the information recorder.

Referring to FIG. 1 and FIG. 2, the magnetic disk drive includes disk 1 which is a magnetic disk or the like data storage medium having recording layer on the surface, spindle motor 2 for revolving disk 1, actuator 3 mounted with slider 21, voice coil motor 4 for driving and sway actuator 3, ramp block 5 provided at a shunt position for actuator 3, inertia arm 6 which forms an inertial latching mechanism for actuator 3, and other items. All these constituent parts are housed within case 7.

The magnetic disk drive is provided with a loading/unloading mechanism and an inertial latching mechanism for actuator 3. When a magnetic disk drive discontinues its operation, actuator 3 is unloaded to a shunt position to be held and retained in there during off-operation.

Disk 1 is fixed on the rotor of spindle motor 2 to be revolving around the spindle axis while the magnetic disk drive is in operation. It comes to a standstill (stops) during off-operation. Disk 1 is provided with tracks (not shown) for storing data and servo information, which are disposed concentric on the surface.

Actuator 3 is formed of head arm 8 and coil arm 9. Actuator 3 is supported to be freely revolvable with sway around the revolving axis of, for example, a complex bearing 10 consisting of a pivotal bearing and a ball bearing, which complex bearing allowing two revolving motions, in disk 1's radius direction and in the direction perpendicular to it. Head arm 8 is formed of carriage arm 11 and suspension arm 12 mounted on carriage arm 11. Suspension arm 12 has tab 13, which is used when shunting to ramp block 5. Tab 13 is held by ramp block 5 while head arm 8 is in the shunt position. Tab 13 is provided with a protrusion (not shown) for making contact with ramp block 5. Suspension arm 12 is mounted with slider 21.

Slider 21 is amounted on head arm 8 so that the slider opposes to the upper surface of disk 1. Slider 21 is coupled via head wire 14, etc. with a control section (not shown). Slider 21 is provided with a head device (not shown), or an information conversion element, which records data coming from the control section in disk 1′ a surface track and reads recorded data from the disk to be sent to the control section. Although slider 21 shown in FIG. 2 is facing only to disk 1's upper surface, it is not limited as such. Head arm 8 may have sliders 21, one to face the upper surface and another to face the lower surface of disk 1. Furthermore, disk 1 is not limited to one disk, it may of course be two disks, three disks or even more counts.

Voice coil motor 4 is formed of coil 15 mounted in the inside of coil arm 9, upper yoke 22, lower yoke 16, permanent magnet 17 attached on the upper surface of lower yoke 16, and other items. Electric power for driving coil 15 is delivered from a control section. Coil arm 9 is disposed in a space between upper yoke 22 and lower yoke 16, coil arm 9's coupling section 9a is coupled with inertia arm 6. Permanent magnet 17 is attached only on lower yoke 16, in FIG. 1 and FIG. 2. However, the permanent magnet may be attached instead to upper yoke 22, or to both upper yoke 22 and lower yoke 16.

Although it is not shown in the drawing, ramp block 5 has a complex surface formed of a plurality of slopes and flat planes to encounter tab 13. Ramp block 15 is fixed on case 7 so that the complex surface faces tab 13 of unloading suspension arm 12, namely, toward the outside edge of disk 1 in the direction of diameter.

A loading/unloading mechanism is formed of actuator 3, voice coil motor 4 and ramp block 5.

Inertia arm 6 is supported by case 7 so that it can revolve freely. Inertia arm 6's coupling section 6a couples with coil arm 9's coupling section 9a. Coupling section of coil arm 9's coupling section 9a and inertia arm 6's coupling section 6a has an involute shape which is generally used among toothed wheels; and the two items are coupled in an engaged state.

Inertia arm 6 is mounted with pulling member 18 which is made of a magnetic material. A drive means is formed by permanent magnet 17 and pulling member 18 which is made of a soft iron or the like material which is pulled by a magnet. During loading operation, pulling member 18 is pulled by permanent magnet 17, and inertia arm 6 is driven clockwise as viewed from above FIG. 1. Inertia arm 6 stays in the driven position; this will be detailed later.

Next, operation of the above-configured magnetic disk drive is described with reference to FIG. 3, FIG. 4, FIG. 5 and FIG. 6.

FIG. 3 illustrates a state where actuator 3 has been loaded. Based on servo information read out by a head device (not shown) mounted on slider 21, slider 21 is moved on a certain specific data track. It records data delivered from the above described control section (not shown) in a surface track of disk 1, or reads stored data out of a disk track for delivery to the control section. Coil arm 9 and inertia arm 6 are uncoupled. Since pulling member 18 is being drawn by permanent magnet 17, inertia arm 6 has been driven clockwise, as viewed from above FIG. 3, coming into contact with case 7's structural member 31. In this way, inertia arm 7 is kept in the state of standby for coupling with coil arm 9. Structural member 31 may be designed so that it also plays the role of a crash stopper for restricting an excessive clockwise revolution of actuator 3.

When the magnetic disk drive is instructed to stop operation, the control section delivers a drive current to coil 15 of voice coil motor 4, and actuator 3 starts unloading operation. Head arm 8 of actuator 3 is unloaded towards the shunt position. FIG. 4 illustrates a state when the slider (not shown) is just before leaving disk 1; the coupling between coil arm 9 and inertia arm 6 remains disengaged. FIG. 5 is a magnified view showing the coupling section of actuator 3's coil arm 9 and inertia arm 6. Referring to FIG. 5, coil arm 9 is provided, in the neighborhood of coupling section with inertia arm 6, with restriction section 9b whose side-wall is formed in a fan shape representing part of a circle concentric with the revolution center of actuator 3, e.g. axis of complex bearing 10 consisting of a pivotal bearing and a ball bearing. On the other hand, inertia arm 6 is provided with contact section 6b. Contact section 6b is disposed opposed to the fan shape side-wall of coil arm 9's restriction section 9b, and driven clockwise, as viewed from above FIG. 4 and FIG. 5, by permanent magnet 17 and pulling member 18, and the clockwise revolution is restricted by structural member 31. The inertia arm has been disposed so that there is a small gap against the surface of the fan shape side-wall of the coil arm, in the above situation. Coil arm 9's restriction section 9b and inertia arm 6's contact section 6b constitute a revolution restriction means for restricting anti-clockwise motion of inertia arm 6, as viewed from above FIG. 4 and FIG. 5; contact section 6b comes into contact with the side-wall of coil arm 9's restriction section 9b and blocks the anti-clockwise revolution of inertia arm 6. Examples of coil arm 9's coupling section 9a and restriction section 9b, and inertia arm 6 are shown in FIG. 6(a) and FIG. 6(b), respectively. FIG. 6(a) is a magnified perspective view of coil arm 9's coupling section 9a, FIG. 6(b) is a perspective view of inertia arm 6 as viewed from the underneath. As seen in FIG. 6, coil arm's coupling section 9a and restriction section 9b, and coil arm's coupling section 9a and contact section 6b, respectively, have been designed for three-dimensional arrangement.

Relative relationship between coil arm 9's coupling section 9a and inertia arm 6's coupling section 6a in each of the operation stages of actuator 3 can be categorized into the following three states: (1) state of finished coupling,. (2) state of ongoing coupling operation, from the moment when coil arm 9's coupling section 9a and inertia arm 6's coupling section 6a come into contact to start the coupling, or just before the moment, until the state of finished coupling, (3) uncoupled state, other than the state of finished coupling and the ongoing coupling operation. In the region corresponding to the uncoupled state, the fan shape of coil arm 9's restriction section 9b resides in an area opposing to inertia arm 6's contact section 6b. The small gap between the fan shape side-wall of coil arm 9's restriction section 9b and inertia arm 6's contact section 6b, which inertia arm is being driven clockwise, as viewed from above FIG. 4 and FIG. 5, by permanent magnet 17 and pulling member 18, and restricted by structural member 31, and in the stance of standby for coupling, is intended to provide a small gap between coil arm 9's coupling section 9a and inertia arm 6's coupling section 6a even in a state when the fan shape side-wall of coil arm 9's restriction section 9b makes contact with inertia arm 6's contact section 6b. In other words, it has been designed to avoid side protrusion 6c of inertia arm 6's coupling section 6a from making a crossing encounter with the tip-end of coil arm 9's coupling section 9a even in a state when the fan shape side-wall of coil arm 9's restriction section 9b is in contact with inertia arm 6's contact section 6b; namely, it has been designed so that cross point 53 of trail 51 marked by the tip-end of inertia arm 6's side protrusion 6c (trail 51 representing a circle marked by the tip-end of involute tooth at inertia arm's coupling section 6a) and trail 52 marked by the tip-end of coil arm 9's coupling section 9a (trail 52 representing a circle marked by the tip-end of involute tooth at coil arm's coupling section 9a) locates somewhere between inertia arm 6's side protrusion 6c and straight line 54 connecting respective revolution centers of coil arm 9 and inertia arm 6. If there is enough space for coil arm 9's restriction section 9b and inertia arm 6's contact section 6b and no designing limitation, it is preferred that the contact point where coil arm 9's restriction section 9b and inertia arm 6's contact section 6b are making contact is locating at a place where a straight line connecting the contact point and the revolution center of coil arm 9 and a straight line connecting the contact point and the revolution center of inertia arm 6 cross substantially perpendicular to each other.

In order to build the above-described structure, coil arm 9 is provided with restriction section 9b and inertia arm 6 is provided with contact section 6b. By so doing, if a magnetic disk drive is hit by a mechanical shock during recording/playback or loading/unloading operations and coil arm 9 and inertia arm 6 are in uncoupled state, inertia arm 6 may revolve anti-clockwise, as viewed from above FIG. 4 and FIG. 5. However, inertia arm 6's contact section 6b comes into contact with the fan shape side-wall of coil arm 9's restriction section 9b, and no further anti-clockwise revolution can be made. If actuator 3 and inertia arm 6 are hit by an anti-clockwise revolving shock during unloading, especially just before coil arm 9 and inertia arm 6 are coupled, inertia arm 6 may revolve anti-clockwise. However, inertia arm 6's contact section 6b comes into contact with the fan shape side-wall of coil arm 9's restriction section 9b, and no further anti-clockwise revolution. Thus, coil arm 9's coupling section 9a of actuator 3 will not make an abnormal collision to inertia arm 6's coupling section 6a, and the stance of standby for engagement of coil arm 9 and inertia arm 6 is ensured to be ready for intrusion of coil arm 9's coupling section 9a into coupling section 6a of inertia arm 6.

FIG. 7 shows a state where head arm 8 is unloaded to a shunt position; coil arm 9 and inertia arm 6 are coupled at the involute coupling section. While head arm 8 is in the shunt position, tab 13 of suspension arm 12 is held and retained by ramp block 5, and disk 1 stops. Afterwards, when the magnetic disk drive is re-started, head arm 8 is loaded from the shunt position to bring a slider (not shown) towards the surface of disk 1, whose revolution has been re-started. The slider is guided to a certain desired disk track based on servo information read out by a head device (not shown) mounted on the slider.

Next, the behavior of actuator 3 and inertia arm 6 when a magnetic disk drive is hit by an external revolving shock during off-operation is described with reference to FIG. 7.

Reference is made to FIG. 7, when hit by an anti-clockwise revolving shock as viewed from the above, actuator 3 is affected by a certain specific anti-clockwise angular acceleration force. Likewise, inertia arm 6 is also affected by an anti-clockwise revolving force. Thus, contradictory forces work at the coupling sections. A dynamics at the coupling section of actuator 3 and inertia arm 6, when they are hit by an anti-clockwise revolving force as viewed from the above, is described referring to FIG. 8.

Now reference is made to FIG. 8, symbols J₁,J₂ represent, respectively, the inertia of actuator 3 and inertia arm 6 to their respective centers of revolution, R₁, R₂ the distance from their respective revolution centers to point C of the engagement, F₁,F₂ the respective forces effective at point C, T₁,T₂ the respective torques due to the forces F₁,F₂. Suppose it is hit by an external revolving shock of angular acceleration β, the requirements for inertia arm 6 to stay unmoved despite a revolution of actuator due to the revolving shock are shown in the formulas below:

Torque T₁ at actuator 3 due to angular acceleration β is shown by (formula 1)
T₁=F₁·R₂=J₁·β (formula 1)

From (formula 1), force F₁ effective at point C of actuator 3 is shown in (formula 2)
F₁=J₁·β/R₁ (formula 2)

Meanwhile, torque T₂ at inertia arm 6 due to angular acceleration β is shown by (formula 3)
T₂=F₂·R₂=J₂·β (formula 3)

From (formula 3), force F₂ effective at point C of inertia arm 6 is shown in (formula 4)
F₂=J₂·β/R₂ (formula 4)

Since respective forces F₁ and F ₂ are in the balanced state at point C, following (formula 5) is obtained
F₁=F₂ (formula 5)

By substituting (formula 2) and (formula 4) for (formula 5), following (formula 6) is obtained
J₁·β/R₁=J₂·β/R₂ (formula 6)

Substitution of (formula 6) makes (formula 7)
J₂/J₁=R₂/R₁ (formula 7)

Now therefore, if (formula 7) is satisfied; namely, if an inertia moment ratio of actuator 3 vs inertia arm 6 is determined to be identical to a ratio of distance from point C to actuator 3′ as revolution center vs distance from point C to inertia arm 6's revolution center, and the coupling part of actuator 3 and inertia arm 6 is placed at the vicinity of a straight line, preferably on the straight line, connecting respective revolution centers of actuator 3 and inertia arm 6, then, the torques T₁ and T₂ at respective coupling sections of actuator 3 and inertia arm 6 become to be equal, as the result, the actions at coupling section are suppressed to each other. Thus, actuator 3 can be prevented from drifting onto the surface of disk 1 even when it is hit by a revolving shock.

Both actuator 3 and inertia arm 6 have been balanced in the mass at their respective centers of revolution, so the influence of linear acceleration due to a shock is suppressed to be the lowest possible.

When it is hit by a clockwise revolving shock, as viewed from above FIG. 7, actuator 3 and inertia arm 6 are likewise affected by certain specific angular acceleration forces, generating contradictory forces at their coupling sections. Since torques at respective coupling sections of actuator 3 and inertia arm 6 are identical to each other, they are suppressed to each other at the coupling section. Namely, actuator 3 is prevented from drifting onto the surface of disk 1, even if it is hit by a revolving shock.

Drive means for inertia arm 6 in the present embodiment is formed with permanent magnet 17 and pulling member 18 in order to hold inertia arm 6 to a right position by making use of a magnetic pulling force. However, it is not limited to the structure described above; inertia arm 6 can be driven instead by means of a spring component, or by making use of an elastic deformation of a resin material, for example.

The drive means is fabricated by attaching pulling member 18 made of a magnetic material to inertia arm 6. Instead, inertia arm 6 may be made with a magnetic material; by so doing, pulling member can be integrated therein, and pulling member 18 can be eliminated.

In the above descriptions, ramp block 5 for guiding actuator 3 to a shunt position has been placed in the neighborhood of disk 5's outer circumference. However, it is not the intension of the present invention to limit the structure to the above-described. Ramp block 5 may of course be placed on a fixing shaft of spindle motor 2 for revolving disk 1, if the motor is an axial mounting type, or on case 7, cover or other structural member of a magnetic disk drive. As such, ramp block 5 may be disposed in the neighborhood of disk 1's revolution center.

The above. descriptions have been based on the load/unload system in which actuator 3 is shunted in ramp block 5 disposed close to the outer circumference of disk 1. However, it is not the intension of the present invention to stick to the system. The present invention can be realized also in the CSS (Contact Start Stop) system, in which actuator 3 is shunted to the inner circumference of disk 1.

Although coil arm 9 and inertia arm 6 in the present embodiment are coupled at the coupling section which has an involute shape, it is not the intension of the present invention to limit the way of coupling to the above-described. Any coupling means would do in so far as it couples actuator 3 and inertia arm 6 well; for example, it may be formed of a column-shape coupling post (for coil arm's coupling section 9a) mounted on actuator 3's coil arm 9 in parallel with actuator 3's revolution axis and inertia arm 6's coupling section 6a which couples loosely with the post. Although coil arm's coupling section 9a in the present embodiment has a protruding shape while inertia arm's coupling section 6a is hollowed, coil arm's coupling section 9a may have a hollowed shape while inertia arm's coupling section 6a is protruding.

Although a magnetic disk drive has been used as the example for information recorder in the present embodiment, it is not limited to magnetic disk drive; the present invention is applicable to magneto-optical disk drives, optical disk drives and other non-contact type information recorders.

As described in the above, an exemplary embodiment of the present invention includes a freely revolvable inertia arm which comes into coupling with an actuator when the actuator's head arm is in shunt position or the vicinity, and released from the coupling when the actuator is close to, or in the neighborhood of, the disk; a drive means which drives the inertia arm to a right position at the point of uncoupling from the actuator by means of a magnetic pulling force. Furthermore, the coil arm, which being a constituent part of actuator, is provided with a restriction section and the inertia arm is provided with a contact section. The coil arm's restriction section and the inertia arm's contact section are disposed so that there is a small gap between them while coil arm's coupling section and inertia arm's coupling section are in uncoupled state. Thereby, a revolution restriction means is formed for restricting an anti-clockwise revolution of inertia arm, as viewed from the above. Even if it is hit by an external revolving shock when actuator is away from shunt position or the neighborhood, for recording/playback or load/unload operation, especially when the actuator is just before coupling with inertia arm, inertia arm's anti-clockwise revolution, as viewed from the above, is restricted and the inertia arm can maintain the stance of standby for coupling with the coil arm, or the actuator. Thus, coupling of the actuator and the inertia arm during unloading can be accomplished without fail. An abnormal collision of coil arm's coupling section against the side protrusion of inertia arm's coupling section, which would lead to a failure of coupling with inertia arm and an unfinished unloading operation, can be avoided.

If it is hit by an external revolving shock when actuator is staying in the shunt position, actuator and inertia arm are affected, respectively, by revolution moments of the same direction. The actuator and the inertia arm suppress their actions to each other at the coupling section, and the actuator is prevented from drifting onto data region. During loading operation, inertia arm is held to a right position at the point of uncoupling from actuator by a drive means, or a magnetic pulling force. Therefore, the uncoupling and coupling operations between inertia arm and actuator at loading/unloading is performed without fail.

Thus, an inertial latching mechanism in the present invention and information recorder using the latching mechanism includes a freely revolvable inertia arm which comes into coupling with an actuator when the actuator's head arm is in shunt position or the vicinity, and released from the coupling when the actuator is close to, or in the neighborhood of, the recording medium; and a drive means which drives the inertia arm to a right position at the point of uncoupling from the actuator by means of a magnetic pulling force. Furthermore, the coil arm, which being a constituent part of actuator, is provided with a restriction section and the inertia arm is provided with a contact section. The coil arm's restriction section and the inertia arm's contact section are disposed so that there is a small gap between them while coil arm's coupling section and inertia arm's coupling section are in uncoupled state. Thereby, a revolution restriction means is formed for restricting an anti-clockwise revolution of inertia arm, as viewed from the above. Even if it is hit by an external revolving shock during recording/playback or loading/unloading operations, inertia arm's anti-clockwise revolution, as viewed from the above, is restricted and the inertia arm can maintain the stance of standby for coupling with the actuator. In this way, coupling between the inertia arm and the actuator during unloading can be accomplished without fail. It is applicable to a magnetic disk drive, an optical disk drive and a magneto-optical disk drive containing the floating type signal conversion device such as magnetic head, optical head, etc., and other disk information recorders.

1. An inertial latching mechanism comprising
an actuator for use in information recorder, which actuator comprising a head arm mounted with a head and a coil arm mounted with a coil, and provided with a coupling section and a restriction section and supported to be freely revolvable with sway around the revolution axis of a bearing; wherein
a mechanism for latching the actuator comprises an inertia arm supported to be freely revolvable and held to a right posture by a drive means, which inertia arm being provided with a coupling section and a contact section, and
the restriction section of the coil arm and the contact section of the inertia arm constitute a means for restricting revolution of the inertia arm.

2. The inertial latching mechanism of claim 1, wherein
the restriction section of the coil arm has a fan shape which is representing part of a circle having a certain specific radius centered at the revolution axis of the actuator.

3. The inertial latching mechanism of claim 2, wherein
the fan shape of coil arm's restriction section is residing in a region opposing to the inertia arm's contact section when the coil arm's coupling section and the inertia arm's coupling section are in an uncoupled state.

4. The inertial latching mechanism of claim 3, wherein
the coil arm's restriction section and the inertia arm's contact section are disposed so that there is a small gap between them when the coil arm's restriction section and the inertia arm's contact section are in an opposing state.

5. The inertial latching mechanism of claim 3, wherein
location of the inertia arm's contact section and a certain specific radius of the fan shape for the coil arm's restriction section are determined so that there is a small gap between the coil arm's coupling section and the inertia arm's coupling section when the coil arm's restriction section and the inertia arm's contact section are making contact.

6. The inertial latching mechanism of claim 1, wherein
the coil arm's coupling section and the inertia arm's coupling section are shaped, respectively, in an involute form.

7. The inertial latching mechanism of claim 1, wherein
the coil arm's coupling section is a column-shape coupling post disposed on the coil arm in parallel with the actuator's revolution axis, which coupling post and the inertia arm's coupling section making a loose engagement.

8. The inertial latching mechanism of claim 1, wherein
the drive means is formed of a magnetic member attached to the inertia arm and a permanent magnet constituting a voice coil motor.

9. The inertial latching mechanism of claim 1, wherein
the drive means is formed of the inertia arm made of a magnetic material and a permanent magnet constituting a voice coil motor.

10. An information recorder containing an inertial latching mechanism comprising
a revolving recording medium provided with a recording layer;
an actuator comprising a head arm mounted with a head and a coil arm mounted with a coil, which actuator being supported to be freely revolvable with sway around the revolution axis of a bearing for loading/unloading the head arm by revolving with sway onto the recording medium;
a voice coil motor comprising the coil mounted on the coil arm, a pair of yokes disposed to be facing to the upper and lower end-faces of the coil and a permanent magnet attached to at least one of the yokes at the surface facing to the coil; and
a ramp block provided at a shunt position for the actuator; wherein
a mechanism for latching the actuator comprises
a coupling section and a restriction section of the coil arm,
an inertia arm supported to be freely revolvable and held to a right posture by a drive means, and provided with a coupling section and a contact section, and
the restriction section of the coil arm and the contact section of the inertia arm constitute a means for restricting revolution of the inertia arm.

11. The information recorder of claim 10, wherein
the restriction section of the coil arm has a fan shape which is representing part of a circle having a certain specific radius centered at the revolution axis of the actuator.

12. The information recorder of claim 11, wherein
the fan shape of coil arm's restriction section is residing in a region opposing to the inertia arm's contact section when the coil arm's coupling section and the inertia arm's coupling section are in an uncoupled state.

13. The information recorder of claim 12, wherein
the coil arm's restriction section and the inertia arm's contact section are disposed so that there is a small gap between them when the coil arm's restriction section and the inertia arm's contact section are in an opposing state.

14. The information recorder of claim 12, wherein
location of the inertia arm's contact section and a certain specific radius of the fan shape for the coil arm's restriction section are determined so that there is a small gap between the coil arm's coupling section and the inertia arm's coupling section when the coil arm's restriction section and the inertia arm's contact section are making contact.

15. The information recorder of claim 10, wherein
the coil arm's coupling section and the inertia arm's coupling section are shaped, respectively, in an involute form.

16. The information recorder of claim 10, wherein
the coil arm's coupling section is a column-shape coupling post disposed on the coil arm in parallel with the actuator's revolution axis, which coupling post and the inertia arm's coupling section making a loose engagement.

17. The information recorder of claim 10, wherein
the drive means is formed of a magnetic member attached to the inertia arm and a permanent magnet constituting a voice coil motor.

18. The information recorder of claim 10, wherein
the drive means is formed of the inertia arm made of a magnetic material and a permanent magnet constituting a voice coil motor.
